(19) United States
(12) Patent Application Publication
(10) Pub. No.: US 2012/0324335 A1
(43) Pub. Date: Dec. 20, 2012

(54) APPARATUS AND METHOD FOR PROVIDING EDITABLE FLASH FILE

(75) Inventors: Do-Hyeon KIM, Suwon-si (KR); Dong-Hyuk Lee, Seoul (KR); Hee-Bum Ahn, Seoul (KR); Seong-Taek Hwang, Pyeongtaek-si (KR)

(73) Assignee: Samsung Electronics Co., Ltd., Suwon-si (KR)

(21) Appl. No.: 13/242,899

(22) Filed: Sep. 23, 2011

(30) Foreign Application Priority Data
Jun. 16, 2011 (KR) 10-2011-0058523

(51) Int. Cl. G06F 17/00

(52) U.S. Cl. 715/234

(57) ABSTRACT

A method for storing and managing a content-editable Flash file is provided, in which a Flash file is loaded to be edited, data of a predetermined size is loaded from the Flash file, it is determined based on the loaded data whether the Flash file is editable, and editable data is loaded from the Flash file, if the Flash file is editable.

### PRIORITY

This application claims priority under 35 U.S.C. §119(a) to a Korean Patent Application filed in the Korean Intellectual Property Office on Jun. 16, 2011 and assigned Serial No. 10-2011-0058523, the entire disclosure of which is incorporated herein by reference.

### BACKGROUND OF THE INVENTION

1. Field of the Invention

The present invention relates generally to an apparatus and method for editing Flash content, and more particularly, to an apparatus and method for providing an editable Flash file.

2. Description of the Related Art

Both a FLAsh (FLA) file and a ShockWave File (SWF) file can be created in Flash. FLA is a format designed to facilitate generation a movie in Flash and to store the movie, and allows editing of Flash content. Having an extension “swf”, an SWF file is used to display a Flash file on a Web browser. The SWF file is a compiled version of an FLA file.

A conventional process for playing and editing Flash content is illustrated in FIG. 1.

Referring to FIG. 1, in a local device 100, a Flash editor 105 stores an SWF file 115 in a database 110 in order to play Flash content through a Web browser plugin or a stand-alone Flash viewer 125. Although the Flash content is a file in a SWF format, the structure or file format of its metadata may vary depending on what purpose the metadata is used for in applications. For example, while the metadata may be configured simply in an image file, it needs various types of data such as text, eXtensible Markup Language (XML) data for defining a layout, and the like.

The Flash editor 105 also stores an FLA file 120, which is a pre-compilation source file in the database 110. Generally, when Flash content is created using an application capable of producing Flash content, the original versions of objects (text, images, and the like) of the Flash content and screen configuration information should be kept. For this purpose, for example, Adobe provides FLA as an editable Flash data format. For other applications, necessary data is stored and managed in formats specific to the applications in predetermined folders.

Therefore, the FLA file 120 is separately managed in the database 110, for editing the Flash content. The Flash editor 105 may load the FLA file 120 from the database 110 and re-edit the FLA file 120.

When the local device 100 transmits or uploads the SWF file 115 to a Web/remote device 130, the Web/remote device 130 stores it as an SWF file 135 in a database 140. The Web/remote device 130 then loads the SWF file 135 from the database 140 and plays the SWF file 135 in a Flash viewer 145. It is impossible to re-generate the pre-compilation source file of the SWF file 135, that is, the FLA file using the SWF file 135.

As described above, to re-edit Flash content when needed as well as to play it, an SWF file and an FLA file should be separately managed for the Flash content. Moreover, if various unspecified types of metadata are present separately from the actual Flash content file, e.g., the SWF file, management becomes more difficult and the error probability increases due to file loss, and the like. When the SWF file is to be reused through transmission and sharing, the user is inconvenienced because it is impossible to edit the SWF file. Thus, there exists a need for developing a method for facilitating storage and management of a content-editable Flash file by eliminating the constraint of separately managing metadata from an SWF file.

Moreover, a general-purpose Flash content editing tool such as Adobe, Photoshop, and the like is required in order to edit Flash content, even though the Flash content can be used in an application or tool designed for a specific purpose in a mobile or PC environment. Such a general-purpose Flash content editing tool is expensive and must be separately purchased. Therefore, a method for readily editing Flash content without using a general-purpose Flash content editing tool is necessary.

### SUMMARY OF THE INVENTION

An aspect of embodiments of the present invention is to address at least the problems and/or disadvantages and to provide at least the advantages described below. Accordingly, an aspect of embodiments of the present invention is to provide an apparatus and method for facilitating storage and management of a content-editable Flash file.

Another aspect of embodiments of the present invention is to provide an apparatus and method for facilitating storage and management of a Flash file so that Flash content that can be used in a specific application may simply be edited without using a general-purpose Flash content editing tool.

In accordance with an embodiment of the present invention, a method for providing a content-editable Flash file is provided, in which a Flash file is loaded, data of a predetermined size is loaded from the Flash file, it is determined based on the loaded data whether the Flash file is editable, and if the Flash file is editable, editable data is loaded from the Flash file.

In accordance with another embodiment of the present invention, an apparatus for providing an editable Flash file is provided, in which a Flash file is stored in a database, a Flash viewer plays the Flash file, and a dedicated Flash editor loads the Flash file from the database, loads data of a predetermined size from the Flash file, determines based on the loaded data whether the Flash file is editable, and if the Flash file is editable, loads editable data from the Flash file and edits the loaded editable data.

### BRIEF DESCRIPTION OF THE DRAWINGS

The above and other objects, features, aspects and advantages of certain embodiments of the present invention will be more apparent from the following detailed description taken in conjunction with the accompanying drawings, in which:

FIG. 1 illustrates the configuration of a conventional apparatus for storing and editing a Flash file;

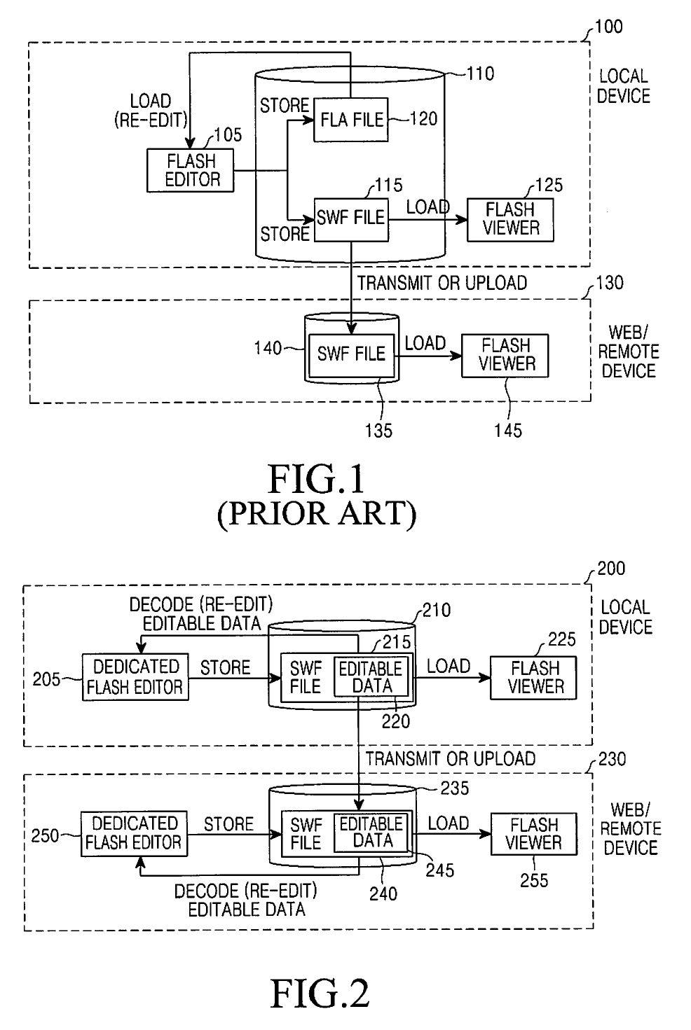

FIG. 2 illustrates the configuration of an apparatus for storing and editing a Flash file according to an embodiment of the present invention;

FIG. 3 illustrates the structure of an editable ShockWave File (SWF) file according to an embodiment of the present invention;

FIG. 4 is a flowchart illustrating an operation for editing a Flash file according to an embodiment of the present invention; and

FIGS. 5, 6 and 7 illustrate the structures of editable data included in a Flash file according to embodiments of the present invention.

### DETAILED DESCRIPTION OF EMBODIMENTS OF THE PRESENT INVENTION

Reference will now be made in detail to the embodiments of the present invention with reference to the accompanying drawings. Throughout the drawings, the same drawing reference numerals will be understood to refer to the same elements, features and structures. While the following description includes specific details such as specific components for the purpose of providing a comprehensive understanding of the present invention, it is to be clearly understood that modifications or changes can be made to them within the scope and spirit of the present invention. Additionally, a detailed description of a generally known function and structure of the present invention will be avoided lest it should obscure the subject matter of the present invention.

An embodiment of the present invention provides a method for storing and managing a content-editable Flash file. For this purpose, a Flash file is extended by adding editable data to the Flash file. Upon receipt of a Flash file, a predetermined amount of data is loaded from the Flash file and it is determined whether the Flash file is editable based on the loaded data. If the Flash file is editable, editable data is loaded from the Flash file. As the present invention provides a Flash file structure that can be edited as well as played in a typical Flash viewer, compatible Flash content can be maintained and file storage and management can be facilitated for editing Flash content.

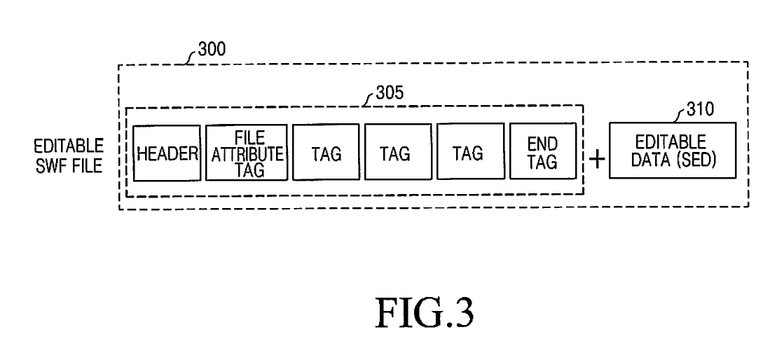

FIG. 2 illustrates a step for storing and managing content-editable Flash file according to an embodiment of the present invention, which will be described below.

Referring to FIG. 2, a Flash file according to the present invention, is configured in such a manner that the Flash file is not only viewable in a Flash viewer 225 but also modifiable according to content editing by a dedicated Flash editor 205. The following description is given of an apparatus for storing and managing a Flash file according to an embodiment of the present invention, which processes a ShockWave File (SWF) file having an “swf” extension.

In a local device 200, the dedicated Flash editor 205 generates an SWF file playable in a typical Flash viewer, especially an extended SWF file configured to include an editable data structure, according to the present invention. The dedicated Flash editor 205 is optimized for a specific application, such as a Flash album editor. The dedicated Flash editor 205 reconfigures the format of an SWF file by extending the SWF file so that the SWF file is playable and editable. Thus, the dedicated Flash editor 205 may generate editable Flash content. When Flash content is to be edited for a specific purpose, the dedicated Flash editor 205 makes unnecessary the need for developing, purchasing, or installing a general-purpose Flash editor, which makes the dedicated Flash editor 205 very useful in a limited environment such as a mobile environment.

The Flash viewer 225 plays an SWF file. Since an extended SWF file according to the present invention keeps all the attributes of a conventional SWF file, it can be played in the Flash viewer 225. The Flash viewer 225 is an SWF-compatible Flash viewer.

Editable data 220 together with an SWF file 215 is stored as an extended SWF file in a database 210. The editable data 220 included in the extended SWF file is metadata needed for editing Flash content, which is data modified based on user editing.

If an SWF file is to be reused through transmission and sharing, the local device 200 uploads the SWF file to a Web/remote device 230. In the Web/remote device 230, a dedicated Flash editor 250 stores the uploaded SWF file in a database 235. In the case where the file is an extended SWF file 240, including editable data 245, the dedicated Flash editor 250 may load the extended SWF file 245 from the database 235 and re-edit the extended SWF file 245. In this manner, even though a file of a SWF format is transmitted to a remote system, the SWF file can be modified and edited, thereby editing Flash content, if the system has a dedicated Flash editor according to the embodiment of the present invention.

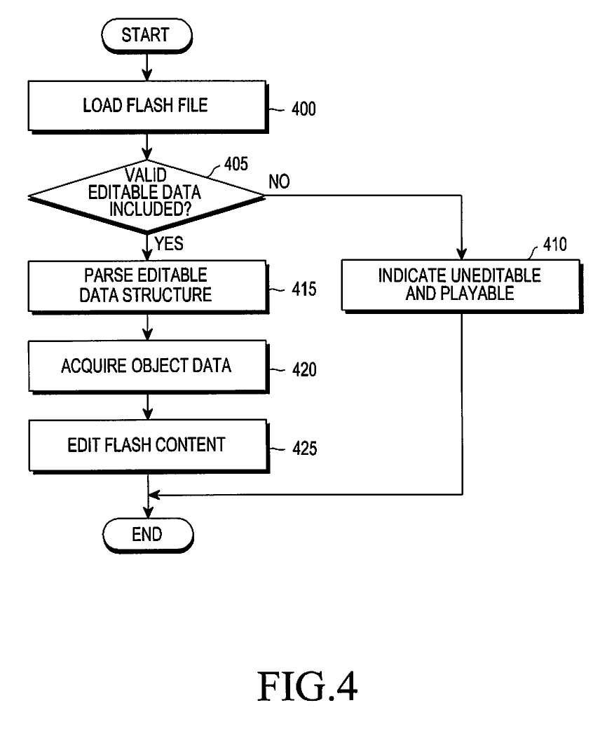

The structure of an extended Flash file according to the present invention is illustrated in FIG. 3.

Referring to FIG. 3, an editable SWF file 300 includes editable data 310 in addition to a conventional SWF file structure 305. In accordance with the present invention, the editable data 310 is Structured Editable Data (SED) added to the end of the SWF file structure 305 to maintain SWF file play compatibility.

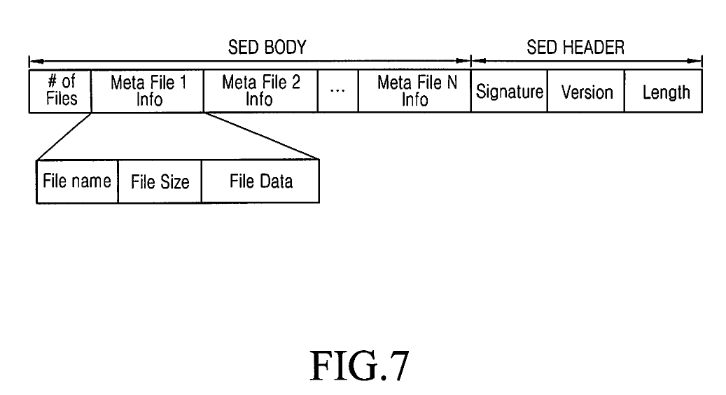

Referring to FIG. 5, the SED is largely divided into an SED header and an SED body. The SED header includes at least one of Signature 500 indicating whether editable data is included, Version 505, and Length 510 indicating the length of the SED body. The SED header has a predetermined size so that the dedicated Flash editor 205 may easily determine whether the SWF file is editable or not.

Therefore, the dedicated Flash editor 205 may easily determine whether an SWF file includes editable data by checking the last data of the predetermined size in the SWF file. In the presence of editable data, the dedicated Flash editor 205 extracts the editable data, that is, multimedia raw data such as images, a video, etc. by parsing the structure of the SED of the SWF file. Since an original Flash file structure is kept intact, the Flash viewer 225 may play the SWF file.

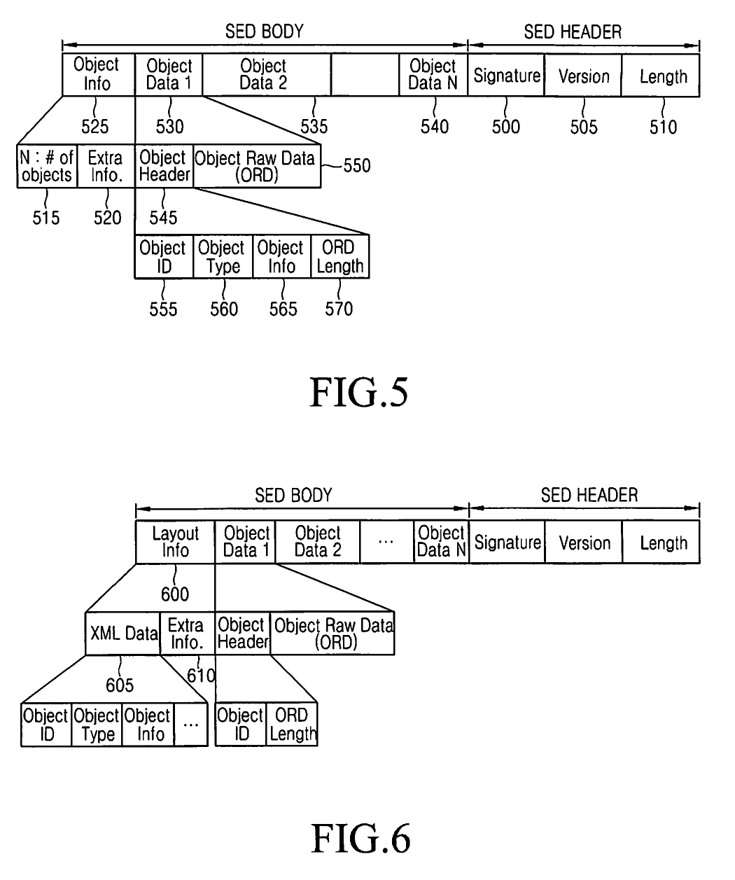

A description will be provided below of the operation of the dedicated Flash editor 205 with reference to FIG. 4.

Referring to FIG. 4, the dedicated Flash editor 205 loads a stored Flash file from the database 210 to edit the Flash file in step 400 and determines whether the Flash file includes valid editable data in step 405. SED may be configured in a data format set for a specific purpose by an application or system. To facilitate determination as to whether a Flash file is editable, a header indicating the presence or absence of editable data resides at the end of the Flash file.

Thus, the dedicated Flash editor 205 reads as much data as a predetermined size, starting from the end of the Flash file. The data of the predetermined size is an SED header. Thus, the dedicated Flash editor 205 determines whether the Flash file is editable by checking the Signature and Version of the SED header. If a predetermined signature is not set in the Signature field or the Version indicates a version not supported in the SED header, the dedicated Flash editor 205 determines that the Flash file is not editable and then proceeds to step 410. Since the Flash file still keeps the format of a conventional Flash file although not having valid editable data, the Flash file may be played like the conventional Flash file. Therefore, the dedicated Flash editor 205 may indicate that the Flash file is not editable but playable in step 410.

To the contrary, in the presence of valid editable data, the dedicated Flash editor 205 loads object data in step 425 by parsing the structure of the editable data in step 415. More specifically, the dedicated Flash editor 205 loads data corresponding to an SED body according to the Length 510 of the SED header. Then, the dedicated Flash editor 205 extracts information about Flash objects and raw data by parsing the structure of Flash content based on the data of the SED body as illustrated in FIG. 5.

If the dedicated Flash editor 205 loads the object data, it edits the Flash content in step 425. As the information about the Flash objects and the raw data are extracted, the dedicated Flash editor 205 may edit individual objects. Objects generically refer to components of Flash content, such as photos, sound, video sequences, a background, text, etc. Hence, one scene may be composed of various objects and Flash content contains a plurality of scenes.

Actual editable data used for editing the Flash content is included in the SED body. The SED body may be a dynamic arrangement of Flash object data or files. When needed, editable data may be included compressed by any compression scheme in the SED body. The editable data may be arranged in various manners as illustrated in FIGS. 5, 6 and 7, which should not be construed as limiting the present invention.

FIG. 5 illustrates a Flash object-based editable data structure. Referring to FIG. 5, the SED body may include Object Info 525 with N: # of Objects 515 indicating the number of Flash objects and Extra Info 520, and Object Data 530, 535 and 540 that provides data of a plurality of individual objects. Each Object Data 530, 535 or 540 may include an Object Header 545 and Object Raw Data (ORD) 550. The Object Header 545 may include Object ID 555, Object Type 560, Object Info 565, and ORD Length 570.

FIG. 6 illustrates an editable data structure having a hierarchical layout. Referring to FIG. 6, an SED body may be configured to have the hierarchical layout of objects described in XML, followed by data of actual individual objects, so that object IDentifiers (IDs) may be referenced. Therefore, Layout Info 600 includes XML Data 605 and Extra Info 610.

FIG. 7 illustrates editable data in a file data structure. Referring to FIG. 7, an SED body may be configured by dynamically concatenating the structures of files needed for editing Flash content. This SED body structure is useful when it is difficult to define data structures in a specific format or file structures are to be kept unchanged.

While it has been described with reference to FIG. 4 that Flash content is edited after the dedicated Flash editor 205 determines whether a Flash file is editable, the process of generating an editable Flash file may be performed in a different manner.

For example, the dedicated Flash editor 205 may load a Flash file stored for re-editing Flash content. Then, upon generation of editable data by re-editing the Flash content, the dedicated Flash editor 205 may structure the editable data in the structure, as illustrated in FIGS. 5, 6 and 7. The structured editable data, i.e., SED is added to the end of the Flash file. The dedicated Flash editor 205 then stores the Flash file including the SED as a single Flash file in the database 210 and manages it.

As is apparent from the above description of the present invention, there is no need for separately storing a playable Flash file in a SWF format and an editable Flash file in a FLA format. Even though an SWF file is transmitted to a remote system, Flash content can be edited if the system has a dedicated Flash editor. Furthermore, it is not necessary to develop, purchase or install a general-purpose Flash editor for using a Flash editing technology in a limited environment such as a mobile environment. In addition, a Flash content editor optimized for a specific application can be created and editable Flash content can be generated.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for providing an editable Flash file, the method comprising:
loading a Flash file;
loading data of a predetermined size from the Flash file;
determining based on the loaded data whether the Flash file is editable; and
if the Flash file is editable, loading editable data from the Flash file.

2. The method of claim 1, wherein the Flash file is a ShockWave File (SWF) file having an “swf” extension.

3. The method of claim 1, wherein data loading comprises:
reading the data of the predetermined size starting from the end of the Flash file.

4. The method of claim 3, wherein the data of the predetermined size comprises:
a Structured Editable Data (SED) header.

5. The method of claim 4, wherein the SED header comprises:
at least one of a signature field representing a signature indicating whether a Flash file is editable, a version field, and a length field indicating a length of an SED body.

6. The method of claim 5, wherein the determination as to whether a Flash file is editable comprises:
determining whether a signature indicating editable is present in the signature field or whether the version field indicates a supported version.

7. The method of claim 6, further comprising:
if the SED header has no signature indicating the Flash file is editable or if the version field indicates a version that is not supported, determining that the Flash file is not editable.

8. The method of claim 5, wherein loading the editable data comprises:
loading data corresponding to the SED body according to a size set in the length field of the SED header;
parsing a structure of the Flash file based on the data corresponding to the SED body; and
editing Flash content by extracting information about Flash objects and raw data through the parsing.

9. An apparatus for providing an editable Flash file, the apparatus comprising:
a database for storing a Flash file;
a Flash viewer for viewing the Flash file; and
a dedicated Flash editor for loading the Flash file from the database, loading data of a predetermined size from the Flash file, determining based on the loaded data whether the Flash file is editable, and if the Flash file is editable, loading editable data from the Flash file and editing the loaded editable data.

10. The apparatus of claim 9, wherein the Flash file is a ShockWave File (SWF) file having an “swf” extension.

11. The apparatus of claim 9, wherein the dedicated Flash editor reads the data of the predetermined size, starting from the end of the Flash file.

12. The apparatus of claim 11, wherein the data of the predetermined size comprises:
a Structured Editable Data (SED) header.

13. The apparatus of claim 12, wherein the SED header comprises:
at least one of a signature field representing a signature indicating whether a Flash file is editable, a version field, and a length field indicating a length of an SED body.

14. The apparatus of claim 13, wherein, if a signature indicating editable is present in the signature field or the version field indicates a supported version, the dedicated Flash editor determines that the Flash file is editable.

15. The apparatus of claim 14, wherein, if a signature indicating editable is not present in the signature field or the version field indicates a version is not supported, the dedicated Flash editor determines that the Flash file is not editable.

16. The apparatus of claim 15, wherein the Flash file that is not editable is playable in the Flash viewer.

17. The apparatus of claim 13, wherein the dedicated Flash editor loads data corresponding to the SED body according to a size set in the length field in the SED header, parses a structure of the Flash file based on the data corresponding to the SED body, and edits Flash content by extracting information about Flash objects and raw data through the parsing.
